(19) United States
(12) Patent Application Publication
(10) Pub. No.: US 2010/0042560 A1
(43) Pub. Date: Feb. 18, 2010

(54) CONTEXT AWARE SOLUTION ASSEMBLY IN CONTACT CENTER APPLICATIONS

(75) Inventors: Maja Vukovic, New York, NY (US); Gopal Pingali, Mohegan Lake, NY (US); Mark E. Podlaseck, Kent, CT (US)

Correspondence Address: CONNOLLY BOVE LODGE & HUTZ LLP;(FOR IBM YORKTOWN), P.O. BOX 2207, WILMINGTON, DE, 19899-2207, US

(73) Assignee: International Business Machines Corporation, Armonk, NY (US)

(21) Appl. No.: 12/190,157

(22) Filed: Aug. 12, 2008

(51) Int. Cl. G06F 15/18

(52) U.S. Cl. 706/12

(57) ABSTRACT

An apparatus and a method is provided for receiving help requests to solve a problem on a computer, generating a core problem description and retrieving at least one of contextual or environmental parameters associated with the computer. The method also includes assembling a formalized problem description. The method further includes obtaining previously stored formalized solution steps associated with the problem from a database and building a customized solution including context aware solution records that are tagged with at least one of contextual or environmental dependencies. The method also includes transmitting the customized solution to the computer for execution and monitoring the execution of the customized solution.

### BACKGROUND OF THE INVENTION

1. Field of the Invention

The present invention is directed to an apparatus and method for dynamically assembling solution records based on the context and the environment parameters associated with a system for which the solution being is generated, thereby providing a model for building context aware solution records that are dynamically composed sequences of solution steps which are tagged with contextual dependencies.

2. Description of the Related Art

Current problem solving scripts and solution procedures are rigid text documents which do not accommodate for context specific approaches to solving a problem. These problem solving scripts and solution procedures often represent a standardized, generic solution to a family of problems. For example, if a problem to be solved is a blocked Lotus Notes™ account, the most common cause is that an associated user forgot the password to the account and exceed the number of times provided for attempting to login with the wrong password. Thus, the most common solution procedure would include steps for resetting the user's password. However, there are cases when, prior to beginning employment at a company, an account is created for a new employee a significant amount of time prior to the employee start date. Consequently, a recovery procedure for unlocking a Lotus Notes™ account would be required to allow the new employee access to the Lotus Notes™ account. The recovery procedure needs to take into account the type of machine being used, the user profile, and previously installed software. As shown above, while two problems may result in the same action, the solutions to these problems may require different steps. Therefore, solutions for solving problems must accommodate the different contexts in which the problems occur.

The problems associated with static problem solving scripts and solution procedures are significant as companies move toward self enablement, that is, empowering users with self help techniques to reduce calls to help desks. To empower users to solve their own problems without support from a help desk support agent, companies have started to open up parts or all of their solution databases to end users. However, as noted above, the problem solving scripts and solution procedures in these databases are inflexible and static and they are limited to standard encoded procedures. Thus, each new solution to a given problem is rewritten by a dedicated subject matter expert each time a new device or software is introduced to the market or a new conflict between configurations settings is detected.

Current approaches of documenting solutions, including best practices solutions, are limited in that they do not include the full scope of problems. These approaches also do not go beyond taking into account a user's machine. Despite the enormous amount of information that is embedded in today's problem resolution records and available in the solution databases, there is no mechanism to encode the problems and solutions in a structured way. As a result, no steps of one solution can be easily reused to solve another problem. Furthermore, there is a loss of knowledge as specific user and environment context parameters are not often recorded in the problem resolution record; and therefore, they do not appear in the solution databases.

### BRIEF SUMMARY OF THE INVENTION

The present invention is directed to an apparatus and a method for building context aware solution records that are dynamically composed sequences of solution steps which are tagged with contextual dependencies.

An embodiment of the invention is directed to a method including receiving help requests to solve a problem on a computer, generating a core problem description and retrieving at least one of contextual or environmental parameters associated with the computer. The method also includes assembling a formalized problem description. The method further includes obtaining previously stored formalized solution steps associated with the problem from a database and building a customized solution including context aware solution records that are tagged with at least one of contextual or environmental dependencies. The method also includes transmitting the customized solution to the computer for execution and monitoring the execution of the customized solution.

Another embodiment of the invention is directed to an apparatus including a receiving configured to receive help requests to solve a problem on a computer, a generating configured to generate a core problem description and retrieve at least one of contextual or environmental parameters associated with the computer and an assembling unit configured to assemble a formalized problem description. The apparatus also includes an obtaining configured to obtain previously stored formalized solution steps associated with the problem from a database and build a customized solution including context aware solution records that are tagged with at least one of contextual or environmental dependencies. The apparatus further includes a transmitting unit configured to transmit the customized solution to the computer for execution and a monitoring configured to monitor the execution of the customized solution.

Another embodiment of the invention is directed to a computer program embodied on a computer readable medium, the computer program comprises program code for controlling a processor to execute a method including receiving help requests to solve a problem on a computer, generating a core problem description and retrieving at least one of contextual or environmental parameters associated with the computer, assembling a formalized problem description, obtaining previously stored formalized solution steps associated with the problem from a database and building a customized solution including context aware solution records that are tagged with at least one of contextual or environmental dependencies, transmitting the customized solution to the computer for execution, and monitoring the execution of the customized solution.

It should be clear to one skilled in the art that the embodiments summarized above are simply provided as examples of embodiments of the present invention.

### BRIEF DESCRIPTION OF THE DRAWINGS

FIG. 1 illustrates an example of the hardware architecture in which an embodiment of the present invention may be implemented; and

FIG. 2 illustrates the steps implemented in an embodiment of the invention.

### DETAILED DESCRIPTION OF EMBODIMENTS

Embodiments in which the present invention is applied for building context aware solution records that are dynamically composed sequences of solution steps which are tagged with contextual dependencies is described in detail below with reference to the accompanying drawings.

An embodiment of the present invention is directed to dynamically assembling solution records based on the context and the environment parameters associated with a system for which the solution being is generated. A formal model representing solution steps, enriched with contextual dependencies is provided. Based on a problem definition of the user and the environmental context, planning techniques are employed to assemble a sequence of solution steps to be applied automatically or by a help desk agent. Consequently, solution tickets are generated in an automatic fashion.

An embodiment of the present invention also provides a model for building context aware solution records that are dynamically composed sequences of solution steps which are tagged with contextual dependencies. The system employs goal-oriented inferencing from planning technologies for selecting the solution steps and assembling the sequence of their execution, allowing different compositions to result from different context parameters. For example, the context parameters may be resources availability, time constraints and the user location. Contextual changes during the execution of the solution may trigger further re-composition, causing the solution procedure to evolve dynamically.

The system automatically generates a checklist of steps to be performed. The system also records any exceptions to solution steps. An embodiment of the present invention may provide the time estimate duration of each step, based on past execution. As outlined in more detail below, an embodiment of the invention provides the problems and solutions in a formal model and provides for contextual tagging of solutions.

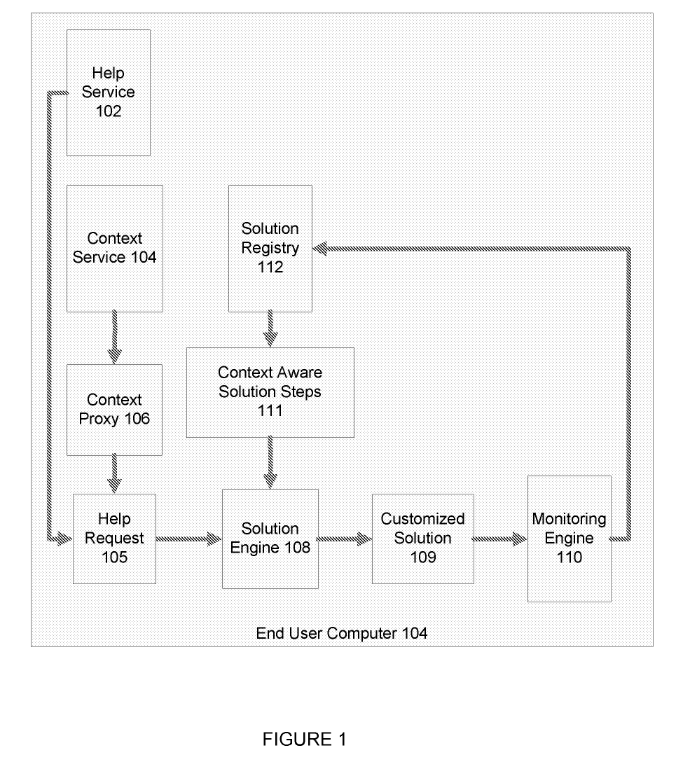

FIG. 1 illustrates an example of a system 100 in which an embodiment of the present invention may be implemented. The system includes a help service 102, a context service 104, a context proxy 106, a solution engine 108, a monitoring engine 110 and a solution registry 112. Help service 102 is configured to receive a help request to solve a problem on a computer associated with a user. As is known to those skilled in the art, user help requests may be transmitted manually, that is through a phone call to a help desk, or electronically, that is directly from the user computer in communications with the system. Upon receipt of a user help request, a core problem description is generated and context service 104 is configured to retrieve contextual parameters. For example, context service 104 may be configured to retrieve contextual parameters such as time, machine details and software installed on the user computer. Context proxy 106 is configured to assemble a formalized problem description, including core system requirements and context requirements and to forward the assembled information (shown as 105 of FIG. 1) to solution engine 108.

Solution engine 108 obtains previously stored formalized solution steps (shown as 111 of FIG. 1) associated with the problem from solution registry 112 to build a customized solution (shown as 109 of FIG. 1). The customized solution is executed on the user's computer. The customized solution may be implemented automatically or manually by the user. Monitoring engine 110 is configured to monitor the execution of the customized solution. This enables the present invention to automatically capture the solution steps and to also capture any deviations from procedures implemented in the customized solution. Such deviations are recorded and may be reused to generate new solution steps. As a result, problem resolution records are automatically generated. When context or execution parameters change, adaptation of the solution procedure is triggered.

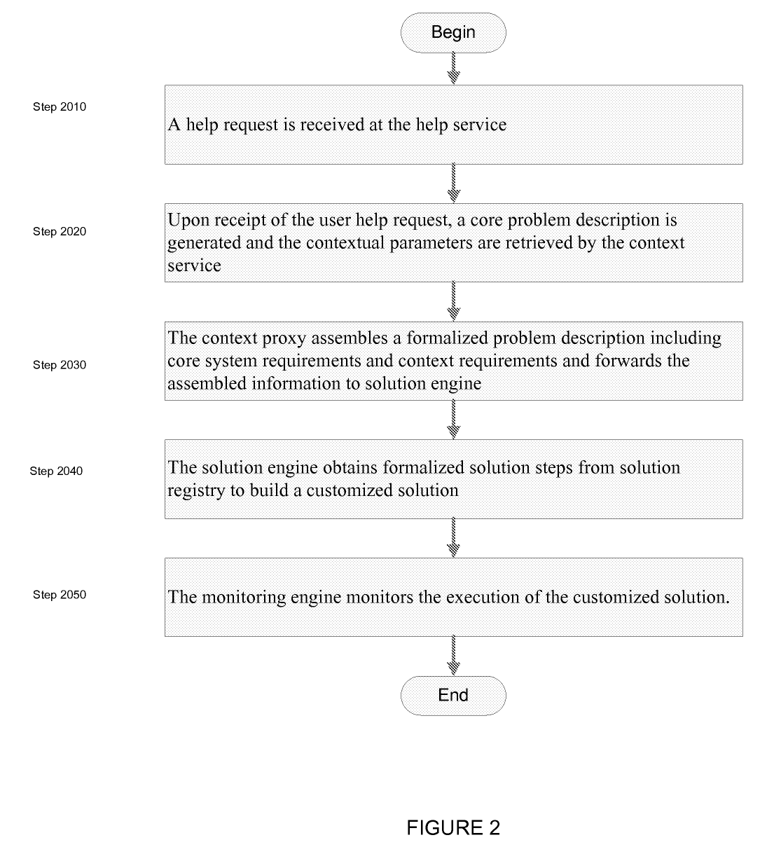

FIG. 2 illustrates the steps implemented in an embodiment of the invention. In Step 2010, a help request is received at help service 102. In Step 2020, upon receipt of the user help request, a core problem description is generated and the contextual parameters are retrieved by context service 104. For example, context service 104 may be configured to retrieve contextual parameters such as time, machine details and software installed on a user computer. In Step 2030, context proxy 106 assembles a formalized problem description including core system requirements and context requirements and forwards the assembled information to solution engine 108.

In Step 2040, solution engine 108 obtains formalized solution steps from solution registry 112 to build a customized solution. The customized solution is executed on the user's computer. In Step 2050, monitoring engine 110 monitors the execution of the customized solution.

Embodiments of the present invention, therefore, increase reuse of existing solutions tickets by mining solution tickets according to established standard procedures. The present invention also allows for a more structured entry of solutions on the front end. The present invention further provides for a solution process monitoring. Contact centers using the present invention may also allocate experts at the right points during the ticket resolution lifecycle. Embodiments of the present invention also provide for handing exceptional cases during ticket resolution, that is, dynamic composition of a solution based on existing solution steps, where each step is tagged by certain problem, precondition or state. This of course leads to more flexible solution procedures. Contact centers using the present invention may separate solution steps performed by the user for those performed by an agent. Embodiments of the present invention, therefore, build a rich history of contextual dependencies and solution steps and provide for end user education.

As should be apparent to one of ordinary skill in the art, the components illustrated in FIG. 1 may be implemented by one or more processing units. The components illustrated in FIG. 1 may also be combined into one or more components which implement the associated functions described above. Similarly, the components illustrated in FIG. 1 may also be separated into one or more components which implement the associated functions described above.

Although the present invention has been shown and described with respect to certain embodiments, it should be understood by those skilled in the art that various modifications can be made to the inventive device and the method of the instant invention without departing from the scope and spirit of the invention. It is intended that the present invention cover modifications and variations of the inventive testing device and method provided they come within the scope of the appended claims and their equivalents.

What is claimed:

1. A method, comprising:
receiving help requests to solve a problem on a computer;
generating a core problem description and retrieving at least one of contextual or environmental parameters associated with the computer;
assembling a formalized problem description;
obtaining previously stored formalized solution steps associated with the problem from a database and building a customized solution including context aware solution records that are tagged with at least one of contextual or environmental dependencies;
transmitting the customized solution to the computer for execution; and
monitoring the execution of the customized solution.

2. The method of claim 1, wherein the receiving help requests comprises receiving help requests manually or electronically at a help desk.

3. The method of claim 1, wherein the assembling a formalized problem description comprises including at least one of core system requirements or context requirements with other information associated with the problem.

4. The method of claim 1, wherein the monitoring comprises automatically capturing execution of the customized solution and any deviations from procedures of the customized solution.

5. The method of claim 4, wherein the deviations are recorded to be used to generate new solution steps, thereby automatically generating problem resolution records and triggering adaption of the solution procedures.

6. The method of claim 1, wherein the context aware solution records are dynamically composed sequences of solution steps.

7. The method of claim 1, wherein the building a customized solution comprises selecting at least one of previously stored or newly created solution steps and dynamically assembling the sequence of their execution, thereby allowing different compositions to result from different contextual and environmental parameters.

8. The method of claim 1, further comprising recomposing the solution based on at least one of contextual or environmental changes during execution of the solution.

9. An apparatus, comprising:
a receiving configured to receive help requests to solve a problem on a computer;
a generating configured to generate a core problem description and retrieve at least one of contextual or environmental parameters associated with the computer;
an assembling unit configured to assemble a formalized problem description;
an obtaining configured to obtain previously stored formalized solution steps associated with the problem from a database and build a customized solution including context aware solution records that are tagged with at least one of contextual or environmental dependencies;
a transmitting unit configured to transmit the customized solution to the computer for execution; and
a monitoring configured to monitor the execution of the customized solution.

10. The apparatus of claim 9, wherein the receiving unit is configured to receive help requests manually or electronically at a help desk.

11. The apparatus of claim 9, wherein the assembling unit is configured to include at least one of core system requirements or context requirements with other information associated with the problem.

12. The apparatus of claim 9, wherein the monitoring unit is configured to automatically capture execution of the customized solution and any deviations from procedures of the customized solution.

13. The apparatus of claim 12, wherein the deviations are recorded to be used to generate new solution steps, thereby automatically generating problem resolution records and triggering adaption of the solution procedures.

14. The apparatus of claim 9, wherein the context aware solution records are dynamically composed sequences of solution steps.

15. The apparatus of claim 9, wherein the obtaining unit is configured to build the customized solution by selecting at least one of previously stored or newly created solution steps and dynamically assembling the sequence of their execution, thereby allowing different compositions to result from different contextual and environmental parameters.

16. The apparatus of claim 9, wherein the obtaining unit is configured recompose the solution based on at least one of contextual or environmental changes during execution of the solution.

17. A computer program embodied on a computer readable medium, the computer program comprises program code for controlling a processor to execute a method comprising:
receiving help requests to solve a problem on a computer;
generating a core problem description and retrieving at least one of contextual or environmental parameters associated with the computer;
assembling a formalized problem description;
obtaining previously stored formalized solution steps associated with the problem from a database and building a customized solution including context aware solution records that are tagged with at least one of contextual or environmental dependencies;
transmitting the customized solution to the computer for execution; and
monitoring the execution of the customized solution.
